(19) United States
(12) Patent Application Publication
(10) Pub. No.: US 2010/0272317 A1
(43) Pub. Date: Oct. 28, 2010

(54) PARKED VEHICLE LOCATION SYSTEM

(75) Inventors: Pablo Riesco Prieto, Pozuelo de Alarcon (ES); Javier Riesco Prieto, Pozuelo de Alarcon (ES); Lourdes Gacho Conde, Pozuelo de Alarcon (ES); Marina Riesco Gacho, Pozuelo de Alarcon (ES); Sara Riesco Gacho, Pozuelo de Alarcon (ES)

Correspondence Address: MERCHANT & GOULD PC, P.O. BOX 2903, MINNEAPOLIS, MN, 55402-0903, US

(73) Assignee: QUALITY INFORMATION SYSTEMS, S.A., Pozuelo de Alarcon (ES)

(21) Appl. No.: 12/771,225

(22) Filed: Apr. 30, 2010

(30) Foreign Application Priority Data
Oct. 28, 2008 (ES) 200803066

(51) Int. Cl. G06K 9/00

(52) U.S. Cl. 382/105

(57) ABSTRACT

The parked vehicle location system, comprising guiding means (2) distributed in the parking lot; positioning means (4) distributed along the guiding means (2); at least one license plate capturing device (3), comprising traction means for travelling along at least one section (2′,2″) of the guiding means (2); image capturing means (40) for obtaining the license plate of vehicles parked in the parking lot; means for reading (37) the positioning means (4), to determine its position; data transmission means (38) for sending information related to the license plates captured and the position where each license plate was captured to a control unit (5); the control unit (5) with data processing means (52) for obtaining from the information received the license plates of the vehicles parked in the parking lot and the parking space associated with each license plate.

### TECHNICAL FIELD

The invention refers to vehicle location systems used in the interior of enclosed areas intended for the location of these vehicles in some specific physical spaces, usually called parking spaces.

### BACKGROUND

There have existed for a long time license plate reading systems. License plate reading systems have been basically used in parking lots for controlling authorized vehicles, wanted vehicles (the so-called black lists) or for linking a specific license plate to a ticket number. The cameras for license plate reading are usually placed at the parking lot access and exit control points, or even at circulation points in the interior, such as driving lanes or ramps.

License plate reading systems have also been combined with occupied parking space detection systems in order to by, combining both systems information, have a list of the parking spaces where a specific car is most likely to be parked.

However, it is unknown the existence of systems that, based on license plate reading, and without requiring a huge number of cameras, facilitate the exact location of a vehicle in a parking lot, indicating in which physical space or parking space the car is parked.

Therefore, it has been considered that there is a need for an electronic system that allows locating, at a specific time, in which parking space among the ones associated to the interior of a parking lot, a specific car is parked.

### SUMMARY

The invention refers to a parked vehicle location system according to claim 1. Preferred embodiments of the system are defined in the dependent claims.

The system comprises:
guiding means distributed in the parking lot to allow the displacement of at least one license plate capturing device along the driving lanes of the parking lot so as to capture the license plates of the vehicles parked in the parking spaces of the parking lot;
a plurality of positioning means distributed along the guiding means for allowing at least one license plate capturing device circulating along the guiding means to know its position inside the parking lot;
at least one license plate capturing device comprising:
   traction means set up for moving the license plate capturing device along at least one section of the guiding means;
   image capturing means set up for obtaining the image of the license plate of vehicles parked in the parking spaces of the parking lot through which the license plate capturing device closely circulates;
   means for reading the positioning means, through which the license plate capturing device determines its position;
   data transmission means, through which the license plate capturing device sends information related to the license plates captured and the position where each license plate was captured to a control unit;
a control unit, featuring data reception means through which it receives the information sent by the data transmission means of the license plate capturing device, and data processing means set up for obtaining, from the information received, the license plates of the vehicles parked in the parking lot and the parking space associated to each license plate.

The license plate capturing device comprises, in a preferred embodiment, lighting means for allowing the image capturing means to capture the license plates in dark areas.

The traction means of the at least one license plate capturing device preferably comprises at least an engine and at least a driving wheel. In this case, the license plate capturing device may additionally have an encoder for calculating the number of engine revolutions and thus the displacement produced.

The license plate capturing device may comprise data processing means set up for determining its position in the parking lot from the information provided by the reading means of the positioning means and by the encoder. The data processing means may also be set up for, from the images provided by the image capturing means, obtaining the vehicle license plates.

The license plate capturing device may be powered through the guiding means or by an on-board installed battery.

The information related to the captured license plates and the position where each license plate was captured which is sent by the license plate capturing device to the control unit, may comprise the read license plate and the identification of the last positioning means read at the moment of obtaining said license plate. It may also include the image of the license plate captured by the image capturing means along with the identification of the last positioning means, read at the moment of obtaining said image. Optionally, it may also include the displacement facilitated by the encoder.

The image capturing means may comprise two cameras, each one facing each side of the driving lane travelled by the license plate capturing device, for simultaneously capturing the license plates of two parking space rows. In this case, the information related to the captured license plates and the position where each license plate was captured, which is sent by the license plate capturing device to the control unit, may comprise, for each license plate, the identification of the camera with which the license plate image was captured.

The system preferably comprises input means, connected to the control unit, for entering a license plate number corresponding to a vehicle that needs to be located in the interior of a parking lot; the data processing means are set up for finding the location of the wanted vehicle according to the information provided by the at least one license plate capturing device. Additionally, the system may also comprise output means for generating a report indicating the location of the wanted vehicle.

### BRIEF DESCRIPTION OF THE DRAWINGS

There follows a very brief description of a series of drawings that will help to better understand the invention and that are particularly related to an embodiment of said invention which is presented as an illustrative and non-limiting example thereof.

FIG. 1 is a block diagram of the electronic system, showing a series of functional modules of a preferred embodiment of the invention.

FIG. 2 is a plan of a parking lot in which it can be observed a particularization of the invention in which there are two guiding means or displacement rails, one of them a circular-type one and the other a linear-type one.

FIG. 3 is a diagram of the main parts which the lighting and the moving capturing means consist of, in this particular case a double-type one; that is, with two lighting devices and two capturing devices.

### DETAILED DESCRIPTION

The present invention relates to a system that allows knowing, at a specific moment, in which parking space of a parking lot a vehicle is parked. Previous to this, the vehicle has obviously entered the interior of the parking lot, and has found an unoccupied parking space to park, which is identified at least by a parking space number.

The system consists of having a file or a table relating the identification of the parking spaces of the parking lot to the content of the license plates of the vehicles parked in each one of them (for the case of the occupied parking spaces), and a blank license plate if no license plate has been read in that parking space (for the case of unoccupied parking spaces), therefore the system also informs how many parking spaces are occupied and how many are unoccupied, and which are the occupied parking spaces and which are the unoccupied ones.

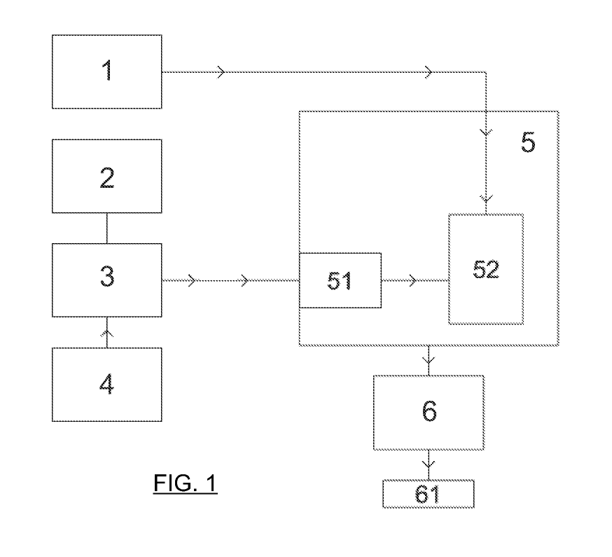

FIG. 1 shows a block diagram of the electronic system that depicts a series of functional modules of a preferred embodiment of the invention. The parked vehicle location system of the present invention consists of:

at least one license plate capturing device 3, having an electric engine and set up for travelling on some guides or rails as it captures the front or rear images of the vehicles parked in the parking spaces;

a control unit 5 with data processing means 52, set up for, from the digital images provided by the license plate capturing device 3 and received through the data reception means 51, processing and extracting the content of the license plate;

guiding means 2, for example displacement guides or rails, by means of which the license plate capturing device 3 travels along the different driving lanes in the parking lot in order to capture the images that will be used for the automatic reading of the vehicles;

a plurality of positioning means 4, for example beacons, RFID labels or magnetic proximity cards, which are distributed along the guides or displacement rails and which are used for the license plate capturing device 3 to know the point where it is located, and to associate said point with the captured images; keeping in mind that, besides, the license plate capturing device may optionally have an encoder or a revolution counter that facilitates the calculation of the displacement produced since the last reading of a positioning device.

The location system also has input means 1 (for example a keyboard or a voice recognition device) to enter a license plate number corresponding to a vehicle that needs to be located in the interior of a parking lot. The data processing means 52 receive from the input means 1 the license plate number and are in charge of locating said vehicle in the interior of the parking lot. The system may have output means 6 (for example a screen or a printer) to generate a report 61 in which the location of the wanted vehicle is indicated.

The system may be set up for the license plate capturing device 3 to be continuously moving and capturing images by means of the guiding means 2, or by contrast, once a first round, in which the state of the parking lot is checked, is completed, and in combination with other parking lot devices such as magnetic loop detectors or parking space occupation detectors, to move only when movement of vehicles is detected or when there is a change in the occupation state of a parking space. This second option is intended basically to save on unnecessary displacement, especially during the hours when there is very little movement of vehicles.

Communication between the license plate capturing device 3 and the control unit 5 is usually carried out via Wi-Fi-type radio frequency, but it is also possible to be performed through the guides or displacement rails themselves, through which in turn it is possible to supply DC power to the license plate capturing device 3. Another option would be powering the license plate capturing device 3 by means of an on-board installed battery.

According to the preferences, the license plate capturing device 3 may or may not have data processing means (for example, a microprocessor) enabling it, from the captured images, to extract or read the content of the license plates. In this case, the license plate capturing device 3 will process the captured images and send the characters read from the license plate to the control unit 5, along with the identification of the last positioning means 4 read, and optionally with the displacement provided by the encoder, along with the identifier of one of the capturing devices out of the two that each license plate capturing device 3 may have, and along with the date and time when the capture was made. Optionally, it may send the captured image. The other option is that the license plate capturing device 3 sends the unprocessed images to the control unit 5, along with the identification of the last positioning means 4 read, and optionally with the displacement facilitated by the encoder, along with the identifier of the capturing device, and along with the date and time when the capture was made, and being in the data processing means 52 of the control unit 5 where the images are analyzed and processed for extracting the license plate content.

In turn, and also according to the preferences, the license plate capturing device 3 may be parameterized so that during the travelling it may be continuously capturing images, or by contrast, so that by means of the electronic control system, it only captures the image when they are approximately centered in front of each parking space.

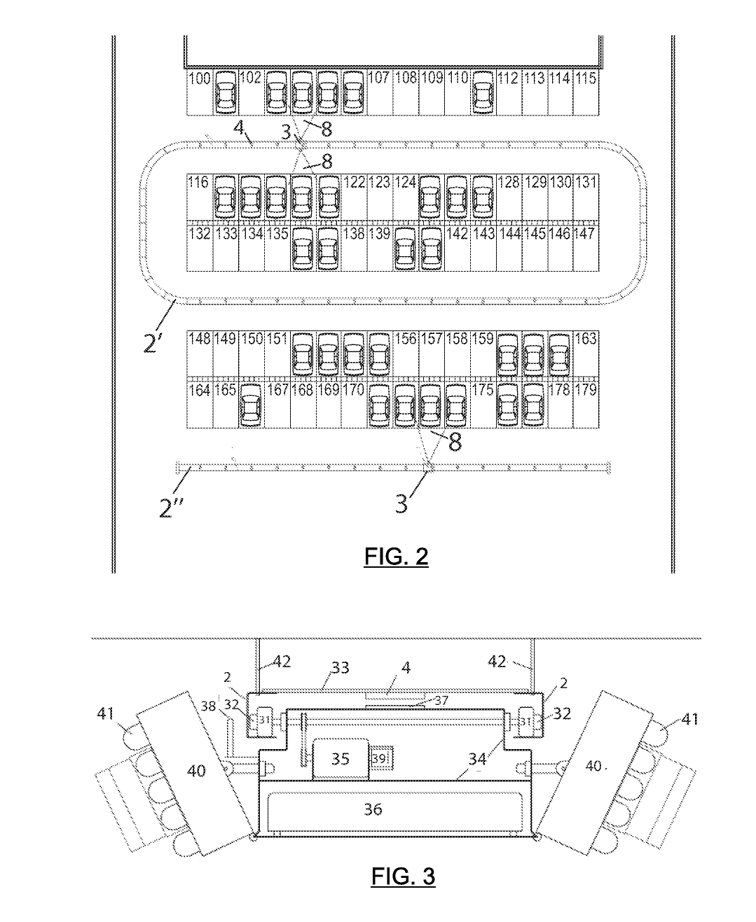

In order to better understand the invention, there is shown as an example in FIG. 2 a plan of a parking lot showing a particularization of the invention in which there are two sections (2′,2″) of guiding means 2, a section 2′ of circular-type displacement rails, for the reading of license plates of the vehicles parked in the spaces between the parking space number 336 and the parking space number 400, and another section 2″ of a lineal-type displacement guide, for the reading of the license plates of the vehicles parked in the parking spaces between the parking space number 320 and the parking space number 335. In turn, in each one of them, there is a double-type license plate capturing device 3 for the circular section 2′, and an individual-type one for the lineal section 2″.

A double-type license plate capturing device 3 travels along a circular section 2′ of the guiding means 2, that is, having two lighting and capturing devices, thus enabling it to capture two parking space rows simultaneously. A simple-type license plate capturing device 3 travels along a linear section 2″ of the guiding means 2, that is, having a single lighting and capturing device, thus enabling it to capture only one parking space row. Each capturing device has a visual field 8, in the case of the double-type license plate capturing device 3 it has two visual fields, one for each camera.

The rails or guides are in turn used to power the license plate capturing devices 3, thus both rails or guides must be isolated from each other. Data transmission is also possible through the guiding means 2.

As the license plate capturing devices 3 travel along the rails, they read the codification of the positioning means 4, usually a magnetic proximity card-type and, optionally by means of the encoder they calculate the displacement, and by means of the capturing devices they capture the images and, in case of having processing capacity, for each one of the capturing means they have, they send, usually via Wi-Fi communication, the following information to the control unit 5:
Date and time of capture.
Identification of the last positioning means 4 read.
Displacement (optional, in the case of having an encoder).
Identification of the associated capturing device.
The license plate alphanumeric character chain in case there is a parked vehicle in the corresponding parking space and a blank chain in case there is no vehicle.
Captured image (optional).

If the license plate capturing device 3 has no processing capacity for reading the license plates, this process must be carried out by the control unit 5, so that for each one of the capturing means available, the following information is sent:
Date and time of capture.
Identification of the last positioning means 4 read.
Displacement (optional, in the case of having an encoder).
Identification of the associated capturing device.
Captured image.

The magnetic proximity positioning means 4 may optionally be completed with the use of encoders which, by means of counting the turns of the small wheels, calculate the displacement of the license plate capturing device 3, being possible to use a mixed system, that is, installing encoders and a smaller number of positioning means 4 so as to refresh or reset the small deviations that the encoders may accumulate.

Likewise, the license plate capturing device 3 may be moving continuously, or by contrast, integrating itself with other parking lot devices such as vehicle detectors or the parking space occupation state detection devices, it may move only when movement of vehicles is detected, or even, this displacement may be directed to the area in which the movement of vehicles was detected.

In this way, the control unit 5, with the information it receives from the license plate capturing device 3, updates the tables that contain the necessary information for, on the one hand locating a wanted license plate, and on the other hand knowing the number of and identifying the parking spaces that are unoccupied and occupied.

Thus, by means of the input means 1 the wanted vehicle license plate is typed, and the control unit 5 detects the location of said vehicle in the parking lot and generates and shows the user (either on a screen or in printed form) by means of the output means 6 a report including the license plate, the identification of the parking space where it is parked, the date and time of the first capture, and the date and time of the last capture.

FIG. 3 shows in detail an embodiment of the license plate capturing device 3, in this particular case a double-type one, that is, with two lighting devices and two capturing devices, for capturing two parking space rows simultaneously, such as the case of the license plate capturing device 3 which circulates along the circular guiding means 2 of FIG. 2. In said FIG. 3 there are shown the different elements that the license plate capturing device 3 may consist of:
vertical wheels 31 and horizontal wheels 32; the vertical wheels 32 are drive wheels, and the horizontal wheels 32 are guiding wheels, especially important at bends.
horizontally joint insulating crossbar 33;
device holding chassis 34;
electric engine 35 for displacement;
electronic control and processing system 36;
reading means 37 of the positioning means 4;
data transmission means 38, such as a Wi-Fi data transmission/reception antenna;
encoder 39 revolution counter;
image capturing means 40 (a camera or any other capturing device);
lighting means 41 for using the capturing device;
fixing rods 42 of the guides or rails.

1. Parked vehicle location system, wherein it comprises:
guiding means distributed in the parking lot to allow the displacement of at least one license plate capturing device along the driving lanes of the parking lot so as to capture the license plates of the vehicles parked in the parking spaces of the parking lot;
a plurality of positioning means distributed along the guiding means to allow at least one license plate capturing device circulating along the guiding means to know its position inside the parking lot;
at least one license plate capturing device comprising:
traction means set up for moving the license plate capturing device along at least one section of the guiding means;
image capturing means set up for obtaining the image of the license plate of vehicles parked in the parking spaces of the parking lot through which the license plate capturing device closely circulates;
means for reading the positioning means, through which the license plate capturing device determines its position;
data transmission means, through which the license plate capturing device sends information related to the license plates captured and the position where each license plate was captured to a control unit; and
a control unit, having data reception means through which it receives the information sent by the data transmission means of the license plate capturing device, and data processing means set up for obtaining from the information received the license plates of the vehicles parked at the parking lot and the parking space associated to each license plate.

2. The parked vehicle location system according to the claim 1, wherein the license plate capturing device additionally has lighting means for allowing the image capturing means to capture the license plates in dark areas.

3. The parked vehicle location system according to claim 2, wherein the traction means of the at least one license plate capturing device comprises at least an engine and at least a drive wheel.

4. The parked vehicle location system according to the claim 3, wherein the license plate capturing device additionally has an encoder for calculating the number of engine revolutions and thus the displacement produced.

5. The parked vehicle location system according to the claim 4, wherein the license plate capturing device comprises data processing means set up for determining its position in the parking lot from the information provided by the reading means of the positioning means and by the encoder.

6. The parked vehicle location system according to claim 5, wherein the license plate capturing device is powered through the guiding means.

7. The parked vehicle location system according to claims 6, wherein the license plate capturing device comprises data processing means set up for, from the images supplied by the image capturing means, obtaining the license plates of the vehicles.

8. The parked vehicle location system according to the claim 7, wherein the information related to the captured license plates and the position where each license plate was captured that is sent by the license plate capturing device to the control unit comprises at least the read license plate along with the identification of the last positioning means read at the moment of obtaining said license plate.

9. The parked vehicle location system according to claim 1, wherein the information related to the captured license plates and the position where each license plate was captured that is sent by the license plate capturing device to the control unit comprises at least the image of the license plate captured by the image capturing means along with the identification of the last positioning means read at the moment of obtaining said image.

10. The parked vehicle location system according to claim 8 when they depend on claim 4, wherein the information related to the captured license plates and the position where each license plate was captured that is sent by the license plate capturing device to the control unit additionally comprises the displacement provided by the encoder.

11. The parked vehicle location system according to claim 1, wherein the image capturing means comprise two cameras, each one facing each side of the driving lane travelled by the license plate capturing device, for simultaneously capturing the license plates of two parking space rows.

12. The parked vehicle location system according to the claim 11, wherein the information related to the captured license plates and the position where each license plate was captured that is sent by the license plate capturing device to the control unit comprises, for each license plate, the identification of the camera with which the license plate image was captured.

13. The parked vehicle location system according to claim 1, wherein it additionally comprises input means, connected to the control unit, for entering a license plate number corresponding to a vehicle that needs to be located in the interior of a parking lot;
and in that the data processing means are set up to find the location of the wanted vehicle according to the information provided by the at least one license plate capturing device.

14. The parked vehicle location system according to claim 13, wherein it additionally comprises output means for generating a report indicating the location of the wanted vehicle.
